(19) United States
(12) Patent Application Publication
(10) Pub. No.: US 2025/0074795 A1
(43) Pub. Date: Mar. 6, 2025

(54) SYSTEMS AND METHODS FOR RECYCLING WATER

(71) Applicant: Renew Health Limited, Athlone (IE)

(72) Inventors: William Tally, Farmington Hills, MI (US); Jeff Dupuis, Farmington Hills, MI (US)

(73) Assignees: Will Tally, Farmington Hills, MI (US); Jeff Dupuis, Farmington Hills, MI (US)

(21) Appl. No.: 18/577,436

(22) PCT Filed: Jul. 8, 2022
(86) PCT No.: PCT/US2022/036560

§ 371 Date: Jan. 8, 2024

Related U.S. Application Data
(60) Provisional application No. 63/219,422, filed on Jul. 8, 2021.

(51) Int. Cl. C02F 1/44

(52) U.S. Cl. CPC C02F 1/441; C02F 2201/005; C02F 2201/007; C02F 2209/006; C02F 2209/10; C02F 2209/40; C02F 2301/046; C02F 2301/08

(57) ABSTRACT

The disclosure relates to systems and methods for recycling water to optimize water treatment. The systems and methods are generally applicable to water treatment where a concentrate fraction is produced, such as water treatment systems that have reverse osmosis components.

### BACKGROUND

There are increasing concerns about the quality of the public water supply. Furthermore, access to the public supply is not available in many situations, including, for example, isolated communities. Consequently, the use of water treatment systems by individuals or businesses has increased and the optimization of these systems is desirable. For example, methods and systems that extract more clean water from the same amount of source or inputted water would be desirable.

### SUMMARY

The disclosure describes systems and methods to recycle water produced by water treatment systems, such as systems that include reverse osmosis components. In preferred examples, systems and methods of the disclosure recycle at least a portion of the concentrate fraction produced by reverse osmosis treatment, where the recycled concentrate is then directed to water treatment systems which further process the water. The recycling of concentrate increases the efficiency and reduces the costs of water treatment, by reducing, for example, the amount of feed water required.

### BRIEF DESCRIPTION OF FIGURES

FIG. 1 shows the flow of water through fluidly linked water treatment systems where concentrate is not recycled but sent to waste.

FIG. 2 shows the flow of water through fluidly linked water treatment systems where concentrate according to one example of recycling concentrate.

FIG. 3 shows the flow of water through fluidly linked water treatment systems where concentrate according to further example of recycling concentrate.

FIG. 4 shows the flow of water through fluidly linked water treatment systems where concentrate according to further example of recycling concentrate.

FIG. 5 shows one view of an assembly according to the disclosure, where the assembly has five fluidly linked water treatment systems

FIG. 6 shows a closer view of components of the assembly of FIG. 5.

### DETAILED DESCRIPTION

The systems and methods described herein are not limited in their application to the details of construction and the arrangement of components set forth in this description or illustrated in the drawings. Also, the phraseology and terminology used herein is for the purpose of description only and should not be regarded as limiting. The use of “including”, “comprising”, “having”, “containing, “involving” and variations thereof herein, is meant to encompass the items listed thereafter, equivalents thereof, and additional items, as well as alternate embodiments consisting of the items listed thereafter exclusively.

This disclosure relates to systems and methods for recycling or recirculating water during water treatment. In preferred examples, the systems and methods recycle or recirculate water fractions that would otherwise be sent to waste. As a result, the yield of product water is increased compared to than without recycling the normally rejected water fraction. The systems and methods disclosed here optimize the production of treated water by, for example, increasing efficiencies and reducing overall costs. Recycling of water includes those methods where water fractions resulting from water treatment are subjected to the same or similar water treatment methods to improve or increase product water yield.

According to the disclosure, feed water comes from an external source for the purpose of water treatment, such as, for example, the public water supply. Input water is water flowed into a water treatment system. In some examples, input water is exclusively feed water. For example, feed water only be may inputted when water treatment is initiated. In other examples, input water may be mixture of feed water and water from other sources, such as concentrate.

In preferred examples, the recycling methods of the disclosure are generally applicable to water treatment systems and methods that process feed water into a product water fraction and a rejected water fraction. For example, when feed water is flowed into at least one water treatment systems having reverse osmosis components, the water treatment systems produce a product water (or permeate) fraction and a concentrate fraction, where the concentrate generally has a higher concentration of impurities than the inputted feed water. The concentrate fraction is often sent to waste without further processing.

According to the present disclosure, at least a portion of concentrate formed by reverse osmosis treatment is recycled or recirculated. For example, concentrate may be flowed to at least one inlet of at least one water treatment system, such that the concentrate is subjected to further processing by the components of the water treatment system.

In preferred examples, concentrate is mixed with non-concentrate water before being flowed into at least one water treatment system. In particularly preferred examples, the recycled concentrate fraction is mixed with feed water before being flowed through the inlet of at least one water treatment system for further processing. The mixing of feed water and concentrate reduces the concentration of impurities that may be present in the concentrate such that the specifications of water treatment components are not exceeded. For example, the performance of reverse osmosis membranes may be compromised at high concentrations of certain impurities, or the membranes may become fouled with deposits.

In some examples, concentrate is mixed with feed water and is flowed back to the same water treatment system in which concentrate fraction was originally formed. For example, a user's home may have a single water treatment system employing reverse osmosis components. Feed water may be flowed into the single system, producing product water and concentrate. A portion of the concentrate produced by the single system is recycled and mixed with feed water. The mixture of feed water and concentrate may be flowed back to an inlet of the single water treatment system. In preferred examples, there may be multiple cycles of recycling and processing of concentrate, such that more product water is produced from the concentrate during rounds of recycling and less feed water is required to be inputted.

In some examples, concentrate may be flowed back to the same (first) system that originally produced the concentrate or may be flowed to at least one water treatment systems that is fluidly linked to the first purification system. In some examples, concentrate from two or more water treatment systems may be pooled and flowed to at least one fluidly linked water treatment systems. According to the disclosure, at least one water treatment systems may be fluidly linked with respect to water flowing into the systems, may be fluidly linked with respect to water flowing from the systems or may be fluidly linked with respect to water both flowing into and from the systems. For example, water treatment systems may be fluidly with respect to input water, product water and concentrate.

In examples according to the disclosure, at least two water treatment systems are fluidly linked, or at least three systems are fluidly linked, at least four systems are fluidly linked, at least five systems are fluidly linked, at least six systems are fluidly linked, at least seven systems are linked, or at least eight systems are fluidly linked. According to the disclosure, the systems may be fluidly linked in parallel, fluidly linked in series, or fluidly linked in series and parallel.

When each system is in parallel with other systems, water flows into or from each system approximately simultaneously. For example, feed water may flow into each linked water treatment system simultaneously. Water may flow in parallel from the water treatment systems.

When each system is linked in series, water flows through each system sequentially. For example, water flows into a first water treatment system, then water processed in the first system flows into a second system. When water treatment systems are in parallel and in series, then some systems are in parallel with respect to other systems and in series with other systems. For example, feed water may flow into first and second systems simultaneously, then processed water from both first and second systems may flow into a third system. In this latter example, the first and second systems are in parallel with each other and in series with the third system.

In some examples, the fluidly linked water treatment systems may not be identical. For example, at least one system of the fluidly linked systems may have additional reverse osmosis components compared to other fluidly linked water treatment systems. In other examples, linked systems may include other components for water treatment, including, for example, water sterilization components, or water filtration components.

In some examples, at least one water treatment systems form an assembly. In preferred examples, an assembly comprises at least two fluidly linked water treatment systems. An assembly may also include an input water line, a product water line, or a concentrate line. In particularly preferred examples, an assembly includes at least two fluidly linked water treatment systems, an input line, a product water line, and a concentrate line. The input water line, the product water line, and the concentrate line fluidly link the at least two water treatment systems. The lines are generally pipes made of materials compatible with purified water or materials compatible with high concentration of impurities or both compatible with purified water and water with impurities. In preferred examples, the pipes are formed from plastic.

The input line carries water to be processed to the at least two fluidly linked water treatment systems. The input line may carry only feed water in situations where concentrate is not recycled. The product water line flows product water away from at least two fluidly linked water treatment systems. The concentrate line flows concentrate away from the at least two fluidly linked water systems. Each of input water line, product water line, and concentrate line may include t least one valve placed in the lines where the at least one valve control the flow of water through the lines.

In preferred examples, the concentrate line includes at least one concentrate valve. In preferred examples, there is one concentrate valve corresponding to each water treatment system in an assembly. In other examples, there may be fewer concentrate valves than water treatment systems.

Concentrate valves are positioned in the concentrate line to regulate the flow of concentrate from its corresponding water treatment system. For example, a first system and a second system are fluidly linked and each have a corresponding first concentrate valve and second concentrate valve. When the first concentrate valve is closed, then concentrate from only the first system is redirected, mixed with feed water and flowed to the input water line. When the second concentrate valve is closed and the first concentrate valve is open then concentrate from both the first and second systems are redirected, mixed with feed water and flowed to the input water line.

According to the disclosure, the closing of at least one concentrate valve redirects the flow of a portion of concentrate from being sent to waste and sends that portion to be mixed with feed water. The positioning of the closed valve(s) in the concentrate line determines the amount of concentrate that is recycled. For example, the closing of one concentrate valve may redirect concentrate from a one water treatment system for recycling, may redirect concentrate from two water treatment systems, or may redirect concentrate from more than two water treatment systems. Consequently, the closing of one concentrate valve may result in concentrate originating from one system being mixed with feed water before being flowed to the input water line, may result in concentrate originating from at least two systems being mixed with feed water before being flowed to the input water line, may result in concentrate originating from at least three systems being mixed with feed water before being flowed to the input water line.

In some examples, at least one concentrate valves are manual valves. In some examples, at least one valves have an external power source such as a battery. In some examples valves are automatic valves or solenoid valves.

In preferred examples, the fluidly linked water treatment systems are arranged in a modular manner. Each system operates to produce product water and concentrate independently of the other systems. Each system controls and regulates the production of water independently of the other systems. Systems may be added to an assembly to accommodate requirements for product water. Further, at least one of the linked systems may be taken offline for maintenance or other reasons but the other fluidly linked systems may remain functioning, including the recycling of concentrate.

An assembly according to the disclosure may include additional components including at least one external pump, where the pumps are not enclosed by the water treatment systems. The assembly may also include external sensors, such as TDS sensors, to monitor the characteristics of the mixture of feed and concentrate. External controllers and valves may be to regulate the flow of concentrate and feed water through the assembly, such as through the inlets of the water treatment systems. For example, a controller may prevent the recycling of concentrate, permitting only feed water to be processed.

The use of recycling systems and methods of the disclosure may allow up to 80% of source water to be outputted as product water, or up to 85% source water outputted as product water, or up to 90% source water outputted as product water, or up to 95% of source water to be outputted as product water. The recycling of concentrate does not significantly reduce system performance parameters such as product water outputted (gallons/per minute) for each system.

### EXAMPLES

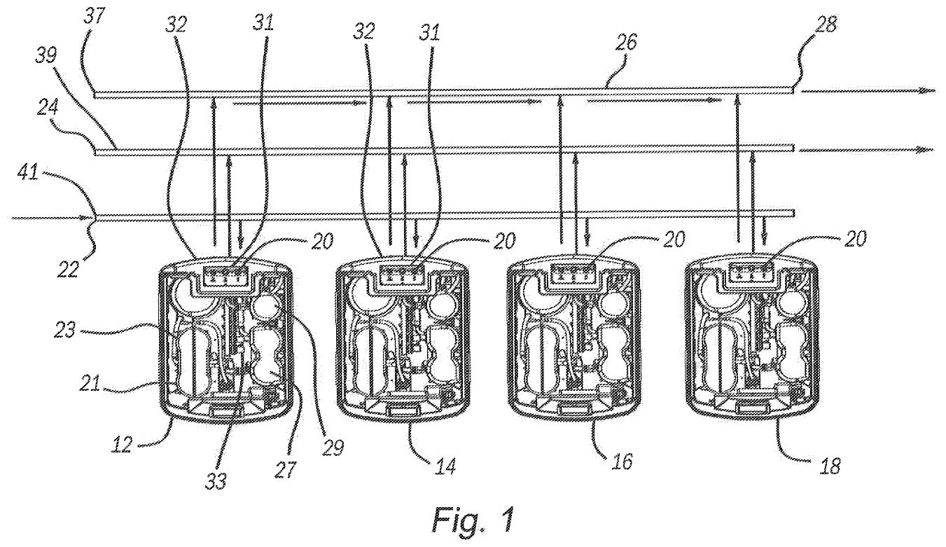

FIGS. 1-4 are schematic diagrams showing the flow of water in examples of the recycling of concentrate. In these examples, the flow of different water fractions is shown by arrows. An assembly of four identical and fluidly linked water treatment systems (12,14,16,18) is shown from above with the lid of each system removed. In these examples, each water treatment system includes filtration components 27, pump 33, reverse osmosis components 27, calcite addition tank, 29 and storage tank 35. Each system also includes an inlet 20 where inputted water flows into a system, a product water outlet 31 where product water flows from a system, and a waste outlet 32 where concentrate flows from a system.

The systems are linked in modular fashion. That is, at least one system may be delinked or removed from the arrangement of systems without affecting the functioning or linkage of the other systems. For example, each system has a controller that monitors system performance such that the system may be shut down without affecting the flow of water through the remaining systems.

In the schematics shown in FIGS. 1-4, input water line 22 flows input water into each of the four systems simultaneously. According to this example, input water passes through line 22 to each of the four inlets 20 of systems 12, 14,16, 18. Systems 12, 14, 16, 18 are placed adjacent to each other in the assembly. System 12 is defined as the first system in the assembly, being the closest to the beginning points 41,39,37 of lines 22, 24 and 26. System 14 is the second system, system 16 is the third system and system 18 is the fourth system.

After processing by the components of each water treatment system, product water flows from each system to product line 24 where the water may then be flowed for storage or use. In FIG. 1, concentrate from each system flows into concentrate line 26 and is sent to waste drain 28. Concentrate is not recycled in this example. In FIG. 1, input water, product water and concentrate flow in the same direction (left to right in FIG. 1). In FIG. 1, concentrate valves are not shown but in this example, the valves are open, resulting in the flow of all concentrate to waste.

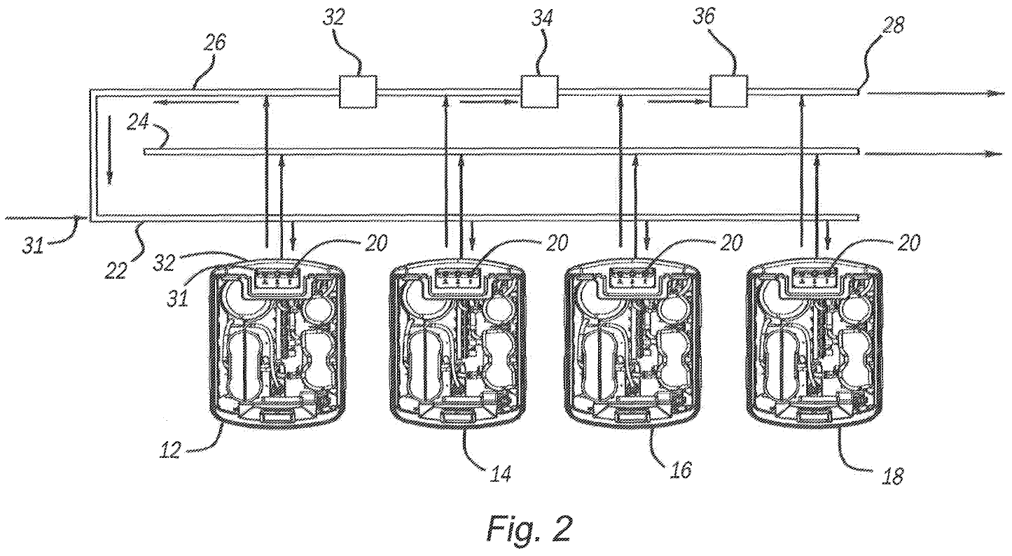

In FIG. 2, at least a portion of concentrate produced by first system 12 is recycled back to systems 12, 14, 16, 18. Concentrate valves 32, 34, 36 are positioned in the concentrate line and are the corresponding concentrate valves for systems 12, 14, 18. In this example, concentrate valves 32, 34, 36 are located just downstream of the point where concentrate flows from each system to the concentrate line and then to waste 28. In this example, first concentrate valve 32 in concentrate line 26 is closed such that at least a portion of concentrate produced by the first system 12 does not flow to waste drain 28. Instead, concentrate from first system 12 flows in the opposite direction in concentrate line 26 back to the beginning point 37 of the concentrate lines 26. That is, the flow of concentrate is reversed in that section of the line between the beginning point of the concentrate line and the concentrate valve. The concentrate then flows into mixing section 31 where concentrate and feed water are mixed and flow into input water line 22. Consequently, input water flowing into input line 22 includes a mixture of both feed water and concentrate, which then flows into systems 12, 14, 16 and 18 through inlets 20. Second and third concentrate valves 34, 36 concentrate line 26 remain open such that concentrate from systems 14, 16 and 18 flow to drain 28.

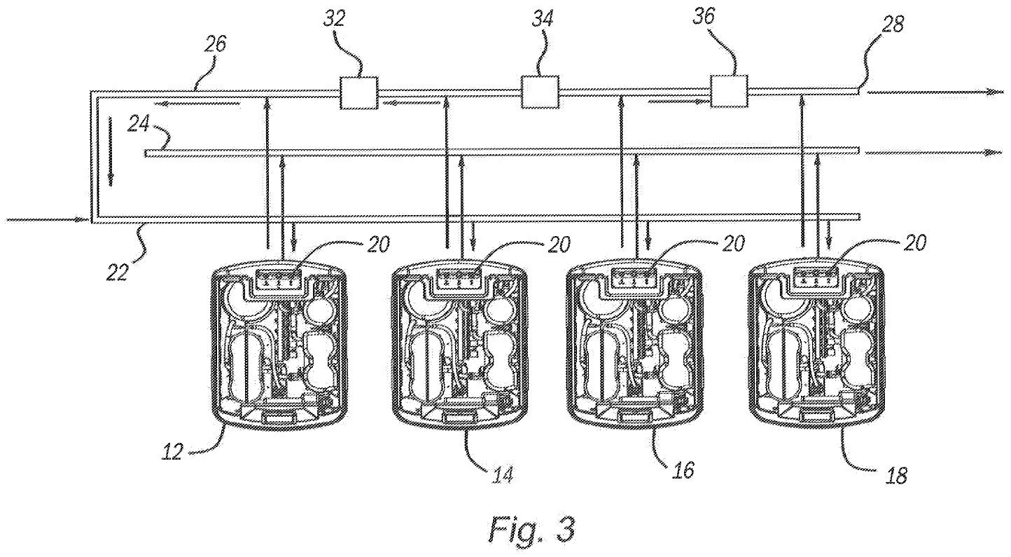

In FIG. 3, at least a portion of concentrate from first and second systems 12, 14 is recycled and mixed with feed water. In this example, second concentrate valve 34, corresponding to second system 14, is closed and first concentrate valve 32 is open such that at least a portion of concentrate from both of systems 12, 14 flows through the concentrate line 26 back to the beginning point 37 of line 26 and is mixed with feed water in mixing section 31. The mixture of feed water and concentrate then flows to input line 22. Third concentrate valve 36 remains open such that concentrate from systems 16 and 18 flows to drain 28.

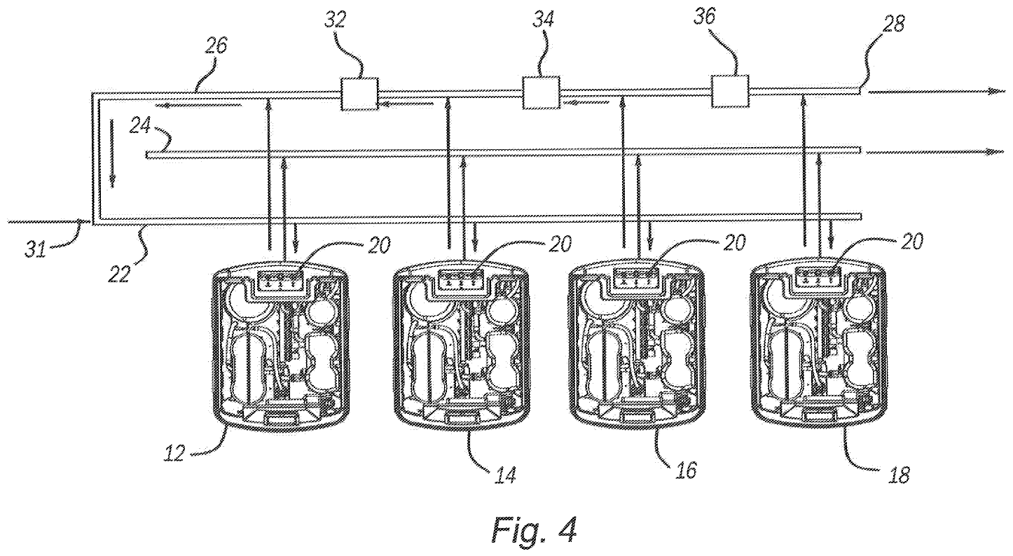

In FIG. 4, at least a portion of concentrate from systems 12, 14, 16 is recycled and mixed with feed water. In this example, third concentrate valve 36, corresponding to third system 16 is closed and first and second concentrate valves 32,24 are open such that at least a portion of concentrate from all three systems 12, 14, 16 flows through concentrate line 26 to the beginning point of the line 37 and then flows into mixing section 31. The mixture of feed water and concentrate then flows to input line 22. In this example, concentrate from system 18 is sent to drain 28.

The degree of mixing of concentrate and feed water may be regulated by the water treatment systems. For example, each system may have tolerances for TDS which should not be exceeded for optimal system performance where the TDS may be monitored by at least one sensor placed in the at least one water treatment system. In some examples, at least one system will shut down if system tolerances are exceeded due to the recycling of concentrate, such that the system is delinked from the assembly.

In some examples, at least one valves or sensors external to the water treatment systems may respond to changes to system parameters. For example, at least one valve or sensor may monitor and respond to changes in flow rates, water pressure or TDS such that the at least one valves may open or close to regulate flow of concentrate through the linked water treatment systems. These automatic control valves may be placed, for example, at least one points in concentrate line 26 or in mixing portion 31. The valves may regulate the amount of concentrate flowing to a drain or to be recycled.

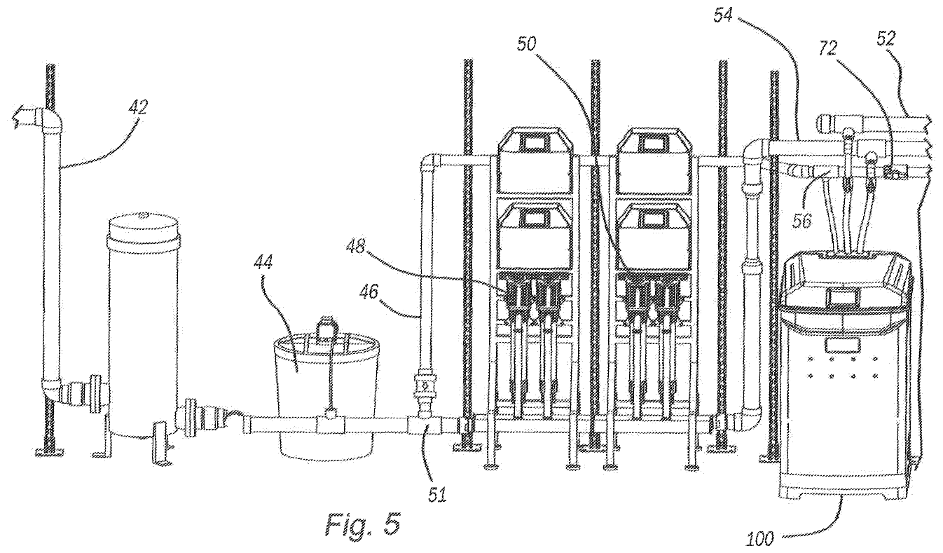

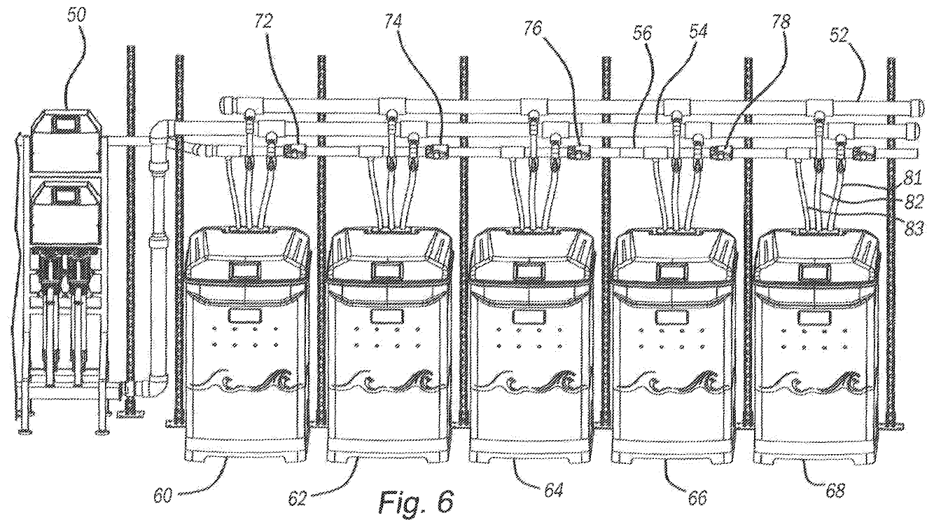

FIGS. 5 and 6 show an example of an assembly of linked water treatment systems that employ the methods of the disclosure for the recycling of concentrate. In FIGS. 5 and 6, five water treatment systems 60,62,64,66,68 are shown placed adjacent to each other where the five systems are fluidly linked and form an assembly.

Water treatment system 60 is defined as the first water treatment system in the assembly, system 62 is defined as the second system in the assembly, system 64 is defined as the third system in the assembly, system 66 is defined as the fourth system in the assembly, and system 68 is defined as the fifth system in the assembly. Input water line 52, product water line 54, and concentrate line 56 are shown and are fluidly linked to the inlet, product outlet and waste outlet of each water treatment system through lines 81,82,83 respectively. In this example, lines 52,54 and 56 are pipes that are placed above the maximum height of the water treatment systems and are positioned approximately perpendicular to the ground. Each of lines 52, 54 and 56 extend approximately the entire span of the linked water treatment systems. That is, each line begins at approximately at the leftward edge of first water treatment system 60 and extends to the rightward edge of fifth water treatment system 68. Concentrate line 56 includes concentrate valves 72,74,76,78 corresponding to water treatment systems 60,62,64,66 respectively. Concentrate valves are inserted in the concentrate line just downstream from where concentrate from a corresponding water treatment system enters the concentrate line. For example, first concentrate valve 72 is positioned just downstream of where concentrate from system 60 enters concentrate line 56. Similarly, second, third and fourth concentrate valves 74,76,78 respectively, are inserted in the concentrate line just downstream of where concentrate from systems 62,64,66 enters the concentrate line.

In FIGS. 5 and 6, concentrate from line 56 flows through line 46 and mixes with feed water at junction 51 when at least one of the concentrate valves is closed. In the example, the amount of concentrate mixed with feed water is determined by the status of at least one of concentrate valves 72,74,76,78. For example, if first concentrate valve 72 is closed, then a portion of concentrate from only first system 60 is recycled and mixed with feed water. If second concentrate valve 74 is closed (and valve 72 is open) then a portion of concentrate from first 60 and second 62 systems is recycled, flowed to be mixed with feed water, then to input line 52.

Pumps 48, 50 are also shown, for pumping input water to line 22 where the inputted water then flows into the inlets of each water treatment system 60,62,64,66,68. Also, shown in FIG. 5 is external feed line 46 and pre-filtration unit 44.

The systems and methods of the examples show improved recovery of product water from inputted water compromising the flow rate of product water from the assembly. In some examples, recycling concentrate from at least one water treatment systems recovers or saves up to 30% of water from being sent to waste.

Obviously, many modifications and variations of the present invention are possible in light of the above teachings. It is, therefore, to be understood that within the scope of the described invention, the invention can be practiced otherwise than as specifically described.

1. A method of increasing the yield of product water, comprising:
a. flowing feed water into at least one inlet of at least one water treatment system, said at least one water treatment system having reverse osmosis components for separation of feed water into product water and concentrate;
b. mixing at least a portion of said concentrate produced by the at least one water treatment system with feed water;
c. flowing said mixture of feed water and concentrate to at least one inlet of said at least one water treatment system.

2. The method of claim 1, wherein feed water is flowed into a single water treatment system and concentrate from said single water treatment system is mixed with a portion of feed water and flowed to said at least one inlet of said single water treatment system.

3. The method of claim 1, wherein an external controller regulates the flow of concentrate and feed water flowed to said at least one inlet of said of said at least two water treatment systems.

4. The method of claim 1, wherein comprising at least two water treatment systems, wherein said at least two water treatment systems are linked in parallel with respect to the flow of input water.

5. A method of recycling water for reverse osmosis:
a. providing an assembly of at least two fluidly linked water treatment systems:
each of said water treatment systems having reverse osmosis components;
said assembly having an input water line, a product water line and a concentrate line, wherein said input water line, said product water line and concentrate line fluidly link said at least two water treatment systems;
said concentrate line having at least one concentrate valve corresponding to at least one of said water treatment systems;
b. flowing feed water through said input water line to each of said at least two water treatment systems, wherein said at least two water treatment systems form concentrate and product water;
c. closing at least one concentrate valve of said at least one concentrate valves, wherein concentrate from said at least water treatment systems corresponding to said concentrate valve flows to mix with feed water;
d. flowing said mix of feed water and concentrate to said input water line.

6. The method of claim 5, wherein closing of said at least one concentrate valve reverses the flow of concentrate in a section of said concentrate line.

7. The method of claim 5, wherein one concentrate valve is closed.

8. The method of claim 7, wherein concentrate from one water treatment systems is mixed with feed water.

9. The method of claim 7, wherein concentrate from at least two treatment systems is mixed with feed water.

10. The method of claim 7, wherein concentrate from at least three treatment systems is mixed with feed water.

11. The method of claim 5, wherein said at least one concentrate valve is selected from the group consisting of manual valves, an automatic valve, solenoid valves and combinations thereof.

12. The method of claim 5, wherein said assembly further comprises at least one external pump.

13. The method of claim 5, wherein said assembly further comprises at least sensor for monitoring the TDS content of said mix of feed water and concentrate.

14. The method of claim 5, wherein said at least two water treatment systems are identical with respect to components contained therein.

15. The method of claim 5, wherein at least one water treatment system may be delinked from said assembly without affect the other systems in the assembly.
